(19) United States
(12) Patent Application Publication
(10) Pub. No.: US 2014/0306417 A1
(43) Pub. Date: Oct. 16, 2014

(54) VEHICLE SUSPENSION TOWER BRACE ASSEMBLY

(71) Applicants: Ronald E. McCormick, Birmingham, MI (US); Vincent Hermann-Heinrich Jones, Troy, MI (US)

(72) Inventors: Ronald E. McCormick, Birmingham, MI (US); Vincent Hermann-Heinrich Jones, Troy, MI (US)

(21) Appl. No.: 14/254,032

(22) Filed: Apr. 16, 2014

Related U.S. Application Data
(60) Provisional application No. 61/812,347, filed on Apr. 16, 2013.

(51) Int. Cl. B62D 25/08

(52) U.S. Cl. CPC B62D 25/088
USPC 280/124.147; 29/897.2

(57) ABSTRACT

A vehicle suspension tower brace assembly includes a first suspension tower attachment, a second suspension tower attachment, and a hollow body. The first suspension tower attachment has an end portion, the second suspension tower attachment has an end portion, and the hollow body has a first end portion and a second end portion. The end portion of the first suspension tower attachment and the first end portion are interconnected via one or more relief(s) and one or more protrusion(s) mating with each other. The end portion of the second suspension tower attachment and the second end portion can be interconnected similarly.

### REFERENCE TO RELATED APPLICATION

This application claims the benefit of U.S. Provisional Patent Application No. 61/812,347 filed Apr. 16, 2013, the entire contents of which are hereby incorporated by reference.

### TECHNICAL FIELD

The present disclosure generally relates to vehicle suspension systems, and more particularly to brace assemblies used to link right-side and left-side vehicle suspensions.

### BACKGROUND

Automobiles are typically equipped with vehicle suspension systems between its wheels and its body or frame for several purposes. Among other possible functions, vehicle suspension systems support the weight of the automobile, cushion bumps and potholes on a road, help maintain traction between automobile tires and the road, and help hold automobile wheels in alignment. But some vehicle suspension systems do not provide the vehicle handling and performance desired.

### SUMMARY

In one embodiment, a vehicle suspension tower brace assembly includes a first suspension tower attachment, a second suspension tower attachment, and a hollow body. The first suspension tower attachment has a flange constructed for mounting to a first suspension tower and has an end portion. The second suspension tower attachment has a flange constructed for mounting to a second suspension tower and has an end portion. The hollow body extends between the first and second suspension tower attachments. The hollow body has a first end portion that axially overlaps the end portion of the first suspension tower attachment, and has a second end portion that axially overlaps the end portion of the second suspension tower attachment. The first end portion and the end portion of the first suspension tower attachment interconnect with each other by way of one or more first relief(s) and one or more first protrusion(s) that mate with each other at a surface-to-surface interface therebetween. The second end portion and the end portion of the second suspension tower attachment interconnect with each other by way of one or more second relief(s) and one or more second protrusion(s) that mate with each other at a surface-to-surface interface therebetween. The interconnecting end portions preclude relative circumferential rotation and relative axial movement between the first suspension tower attachment and the hollow body, and preclude relative circumferential rotation and relative axial movement between the second suspension tower attachment and the hollow body.

### BRIEF DESCRIPTION OF THE DRAWINGS

The following detailed description of example embodiments and best mode is set forth with reference to the accompanying drawings, in which:

FIG. 1 is a perspective view of an embodiment of a vehicle suspension tower brace assembly;

FIG. 2 is a top view of the vehicle suspension tower brace assembly of FIG. 1;

FIG. 3 is a side view of the vehicle suspension tower brace assembly of FIG. 1;

FIG. 4 is a front view of the vehicle suspension tower brace assembly of FIG. 1;

FIG. 5 is a perspective view of an embodiment of a suspension tower attachment of the vehicle suspension tower brace assembly of FIG. 1;

FIG. 6 is a perspective and partially sectioned view showing an interconnection between components in the vehicle suspension tower brace assembly of FIG. 1;

FIG. 7 is a cross-sectional view of an interconnection between components in the vehicle suspension tower brace assembly of FIG. 1;

FIG. 8 is a cross-sectional view of an interconnection between components in the vehicle suspension tower brace assembly of FIG. 1; and

FIG. 9 is a sectional profile view of an interconnection between components in the vehicle suspension tower brace assembly of FIG. 1.

### DETAILED DESCRIPTION

Referring to the drawings, a vehicle suspension tower brace assembly 10 is designed and constructed to serve as a mechanical link between right-side and left-side vehicle suspensions in an automobile. The brace assembly 10 provides a stiffened coupling between opposite vehicle suspensions in order to, among other possible enhancements, improve vehicle handling in cornering, braking, and straight-away driving and maneuvers, and reduce or altogether eliminate relative flex between the vehicle suspensions. The brace assembly 10 can be provided as part of the original equipment of the associated automobile, or can be supplied as an aftermarket component and retrofitted in the automobile.

As an aside, and unless otherwise specified, the terms radially, axially, circumferentially, and their related forms as used in this description refer to directions with respect to the generally cylindrical shape of a hollow body 12 of the brace assembly 10, such that radially refers to a direction generally along and parallel to a radius of the shape, axially refers to a direction generally along or parallel to an axis of the shape, and circumferentially refers to a direction generally around a circumference of the shape.

The brace assembly 10 can be mounted to left-side and right-side suspension towers of a front vehicle suspension or a rear vehicle suspension. The suspension towers can include shock absorber towers, strut towers, or some other suspension component. The exact mounting and installation may depend on the accompanying vehicle suspension system architecture.

The brace assembly 10 and its components can have different designs and constructions depending upon—among other considerations and influences—the vehicle in which the assembly will be installed and the architecture of the accompanying vehicle suspension system. In the embodiment of the figures, for example, the brace assembly 10 is a multi-piece assembly that includes the following separate and discrete components: the hollow body 12, a first suspension tower attachment 14, and a second suspension tower attachment 16.

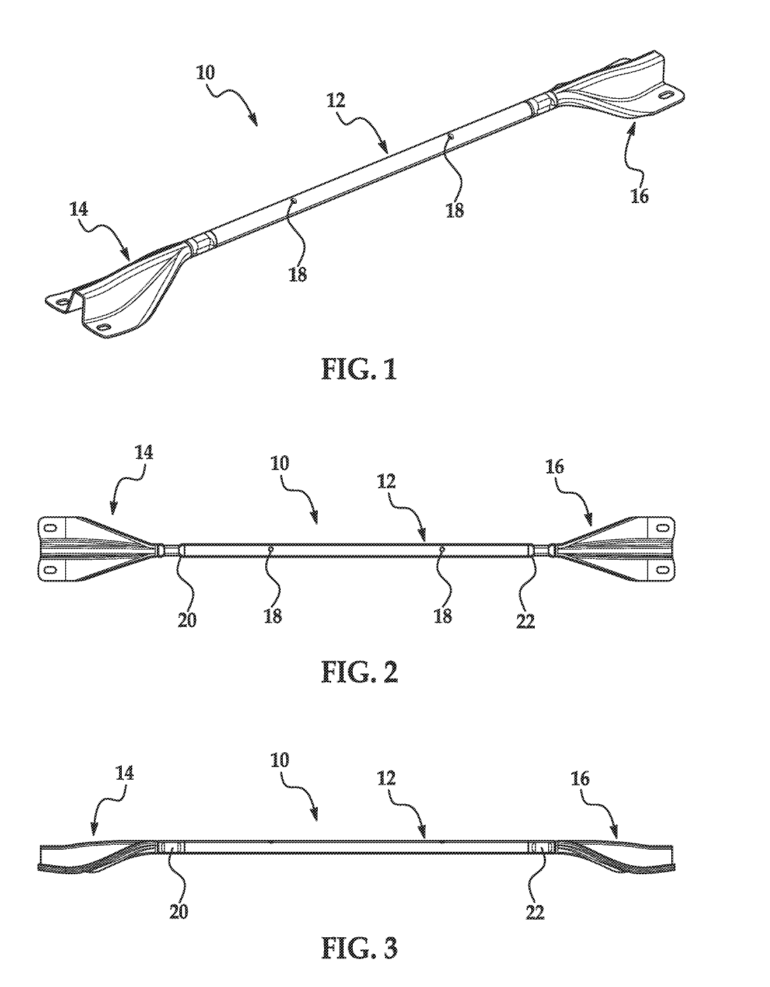

The hollow body 12 extends and spans between the first and second attachments 14, 16. Referring to FIGS. 1-3, the body 12 can be composed of a metal material such as a steel designated by AISI 1018, AISA 1024, or another steel, and has an elongated and uni-directional extent between the first and second attachments 14, 16. In this embodiment, the hollow body 12 is in the form of a tube with a cross-sectional profile that generally resembles a circle. With the exception of its ends, the circular cross-sectional profile does not substantially vary across the hollow body 12. At different places along its extent, the hollow body 12 can have holes 18 that are used as part of a support for a brake line; in other embodiments these holes need not be provided or different holes and/or structures could be provided for a brake line or for some other purpose. The hollow body 12 has a first end portion 20 adjacent the first attachment 14, and has a second end portion 22 adjacent the second attachment 16. The first and second end portions 20, 22 terminate at open ends and constitute terminal end portions of the hollow body 12.

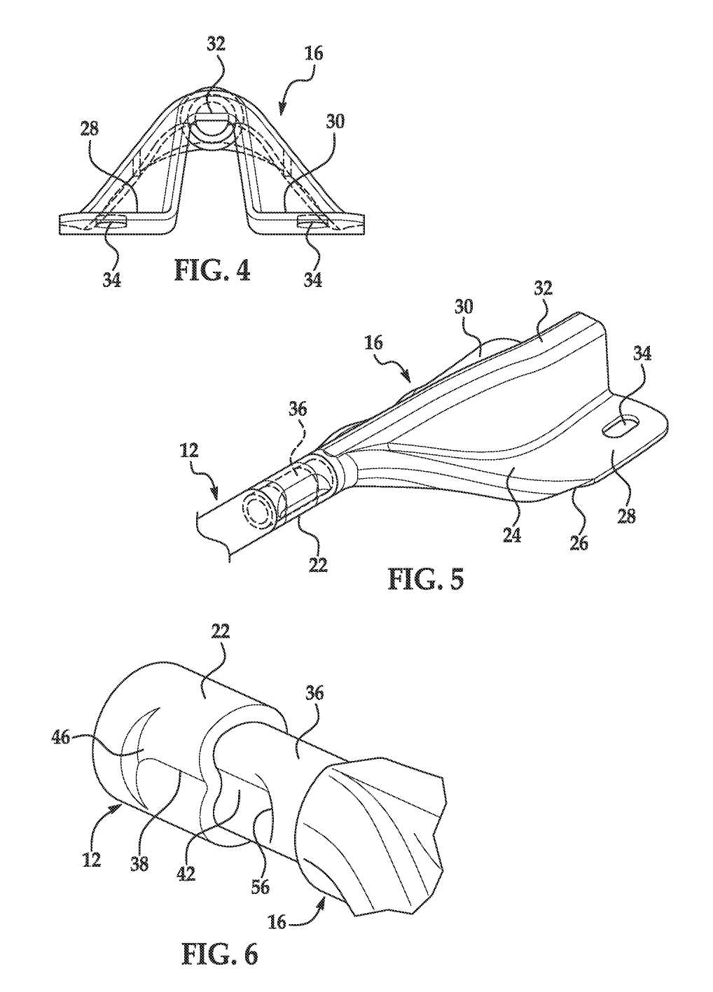

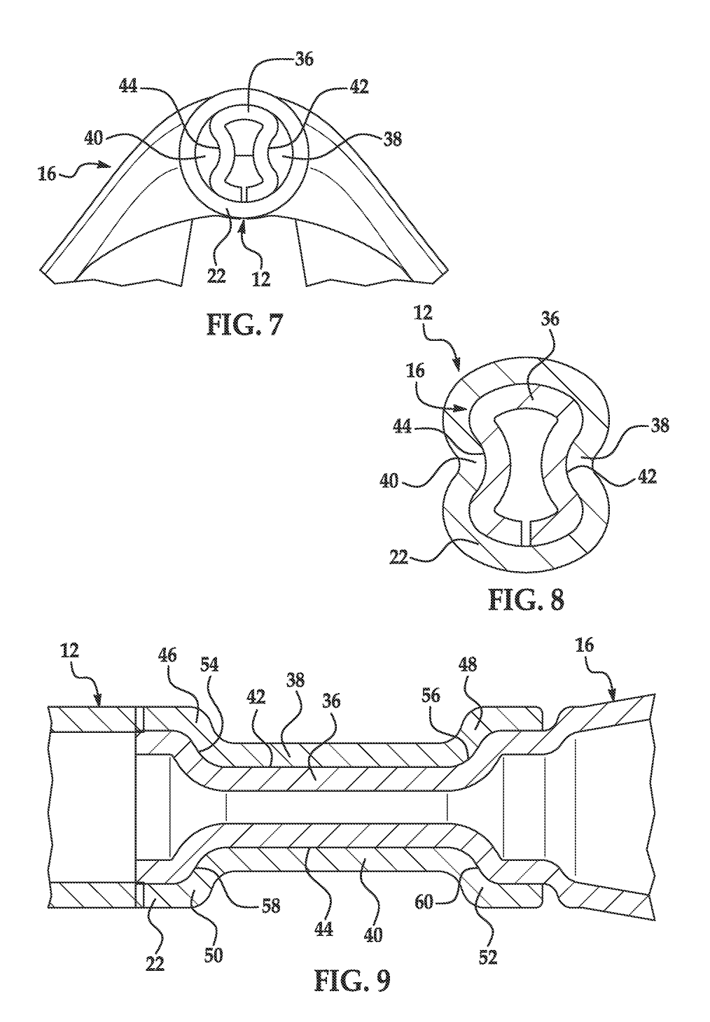

Because in this embodiment the first and second attachments 14, 16 have identical designs and constructions, only one of them is depicted in FIGS. 4-9 and is detailed in this description; the depictions and descriptions apply equally to the other suspension tower attachment. The second attachment 16 is interconnected to the hollow body 12 at the hollow body's second end portion 22 and mounts directly to a suspension tower. Referring now to FIGS. 4 and 5, the second attachment 16 can be composed of a metal material such as a steel designated by AISI 1018, AISA 1024, or another steel, and can be manufactured via a progressive die stamping process or another metalworking process. On one side the second attachment 16 has a top surface 24, and on an opposite side the second attachment has a bottom surface 26 that directly confronts and abuts the suspension tower upon installation of the vehicle suspension tower brace assembly 10.

The second attachment 16 has a first side flange 28 on one lateral side, a second side flange 30 on its other lateral side, and has a raised portion 32 between the side flanges and relative thereto. Each side flange 28, 30 has a bolt hole 34 for mounting via bolting to the suspension tower, and the raised portion 32 strengthens the structural integrity of the second attachment 16. In this embodiment, the second attachment 16 is mounted to the suspension tower without welding; in other embodiments, the mounting can be achieved via riveting, pinning, or another mounting technique, and could involve welding. Furthermore, the second attachment 16 has an end portion 36 that interconnects with the second end portion 22 of the hollow body 12. In other embodiments, the attachments could have different designs and constructions, including having only a single flange and/or some other strengthening structure besides the raised portion.

In the embodiment of the figures, the hollow body 12 and the second attachment 16 are secured together via an overlapping mechanical interconnection and interengagement that precludes relative circumferential rotation and axial movement. The interconnection and interengagement can be designed and constructed in different ways, including that shown by FIGS. 6-9. Here, the end portion 36 of the second attachment 16 is inserted inside of the second end portion 22 of the hollow body 12; in other embodiments, the hollow body's second end portion could be inserted inside of the end portion of the second attachment. In other words, in the embodiment of the figures, the end portion 36 has a smaller diameter than a diameter of the second end portion 22. Before insertion, the end portion 36 and the second end portion 22 can have complementary plain and somewhat tubular shapes that are free of any reliefs, protrusions, or other structures.

Once brought together and axially overlapped, a metalworking process can be performed to the end portions 22, 36 to secure the hollow body 12 and second attachment 16 together and hence preclude relative movement between them. In the embodiment of FIGS. 6-9, a crimping process is performed that simultaneously deforms walls of the end portions 22, 36 so that the walls abut and engage each other. FIGS. 6-9 show the end portions 22, 36 after the crimping process is performed and depicts their resulting abutment and engagement.

In this embodiment, the crimping process produces a first protrusion 38 and a second protrusion 40 in the hollow body 12, and a first relief 42 and a second relief 44 in the second attachment 16. Because the protrusions and reliefs are formed at the same time and in the same process, they are complementary to each other and inter-fit with each other without substantial clearances or gaps therebetween. The protrusions project radially inwardly and the reliefs are indented radially inwardly to a similar extent. Specifically, the first protrusion 38 and first relief 42 mate with each other at a surface-to-surface interface, and likewise the second protrusion 40 and second relief 44 mate with each other at a surface-to-surface interface. The first protrusion and relief 38, 42 have a similar axial extent, and the second protrusion and relief 40, 44 also have a similar axial extent. By their orientation and configuration, the protrusions and reliefs 38, 40, 42, 44 preclude relative circumferential rotation between the hollow body 12 and the second attachment 16.

Furthermore, the crimping process produces third, fourth, fifth, and sixth protrusions 46, 48, 50, 52 in the hollow body 12, and complementary third, fourth, fifth, and sixth reliefs 54, 56, 58, 60 in the second attachment 16. These protrusions and reliefs are perhaps shown best in FIGS. 6 and 9; FIG. 6 depicts the second end portion 22 broken away for illustrative and demonstrative purposes. They are similar to the protrusions and reliefs 38, 40, 42, 44 described immediately above, but are oriented and configured differently. The protrusions and reliefs 46, 48, 50, 52, 54, 56, 58, 60 have an extent that is transverse and orthogonal to the axial extent of the protrusions and reliefs 38, 40, 42, 44. By this transverse orientation and configuration, the protrusions and reliefs 46, 48, 50, 52, 54, 56, 58, 60 preclude relative axial sliding and movement between the hollow body 12 and the second attachment 16. Like the previous protrusions and reliefs, the protrusions 46, 48, 50, 52, 54 56, 58, 60 exhibit a substantially gap free and clearance free surface-to-surface interface therebetween.

In this embodiment, the interconnection and interengagement is accomplished via walls of the hollow body 12 and walls of the second attachment 16, and without welding to produce a weldment or external items such as dowel pins, bolts, and rivets. When accomplished via solely by the interconnecting and interengaging walls, the resulting connection between the hollow body 12 and attachments 14, 16 has been shown to be structurally efficient and cost effective. In other embodiments, however, welding can be involved and external items can be used. Still, in other embodiments a heat-activated adhesive can be applied between the overlapping end portions of the hollow body 12 and second attachment 16.

Moreover, in embodiments not shown in the figures, the interconnection and interengagement could include any number of protrusions and reliefs, and in any orientation and configuration that precludes separation and relative movement between the hollow body and second attachment. And the interconnection and interengagement between the first attachment and hollow body need not necessarily be identical to that of the second attachment and hollow body, even though both interconnections and interengagements can involve reliefs and protrusions.

In yet other embodiments, before the hollow body and suspension tower attachment are brought together, one of their end portions could have one or more reliefs, protrusions, or both, to produce a spline-like construction, while the end portion of the other component could be plain and free of reliefs and protrusions; after the end portions are brought together, the plain end portion could be deformed via a metalworking process to engage the already-formed reliefs, protrusions, or both, and thereby secure the hollow body and suspension tower attachment together. Still, in another embodiment, the interconnection and interengagement could consist of a single relief and complementary protrusion engaged together and configured to preclude all circumferential rotation and axial movement.

While the forms of the embodiments herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A vehicle suspension tower brace assembly, comprising:
a first suspension tower attachment, said first suspension tower attachment having a flange constructed for mounting to a first suspension tower and having an end portion;
a second suspension tower attachment, said second suspension tower attachment having a flange constructed for mounting to a second suspension tower and having an end portion; and
a hollow body extending between said first and second suspension tower attachments, said hollow body having a first end portion axially overlapping said end portion of said first suspension tower attachment and having a second end portion axially overlapping said end portion of said second suspension tower attachment, said first end portion and said end portion of said first suspension tower attachment interconnecting with each other via at least one first relief and at least one first protrusion that mate with each other at a surface-to-surface interface therebetween, said second end portion and said end portion of said second suspension tower attachment interconnecting with each other via at least one second relief and at least one second protrusion that mate with each other at a surface-to-surface interface therebetween, the interconnecting end portions precluding relative circumferential rotation and axial movement between said first suspension tower attachment and said hollow body and precluding relative circumferential rotation and axial movement between said second suspension tower attachment and said hollow body.

2. A vehicle suspension tower brace assembly as set forth in claim 1, wherein the interconnecting end portions between said first suspension tower attachment and second suspension tower attachment and said hollow body lack a weldment thereat.

3. A vehicle suspension tower brace assembly as set forth in claim 1, wherein the interconnecting end portions between said first suspension tower attachment and second suspension tower attachment and said hollow body lack an external item thereat.

4. A vehicle suspension tower brace assembly as set forth in claim 1, wherein said at least one first relief and said at least one first protrusion mate with each other at the surface-to-surface interface and without a substantial clearance therebetween and thereat, and wherein said at least one second relief and said at least one second protrusion mate with each other at the surface-to-surface interface and without a substantial clearance therebetween and thereat.

5. A vehicle suspension tower brace assembly as set forth in claim 1, wherein said at least one first relief includes a first relief in said end portion of said first suspension tower attachment and said at least one first protrusion includes a first protrusion in said first end portion of said hollow body, said first relief and first protrusion mating with each other, said at least one second relief includes a second relief in said end portion of said second suspension tower attachment and said at least one second protrusion includes a second protrusion in said second end portion of said hollow body, said second relief and second protrusion mating with each other.

6. A vehicle suspension tower brace assembly as set forth in claim 1, wherein said at least one first relief includes a first relief and a second relief, said at least one first protrusion includes a first protrusion and a second protrusion, said first relief and first protrusion mating with each other, said second relief and second protrusion mating with each other, said at least one second relief includes a third relief and a fourth relief, said at least one second protrusion includes a third protrusion and a fourth protrusion, said third relief and third protrusion mating with each other, said fourth relief and fourth protrusion mating with each other.

7. A vehicle suspension tower brace assembly as set forth in claim 6, wherein the mating first relief and first protrusion preclude relative circumferential rotation between said first end portion and said end portion of said first suspension tower attachment, the mating second relief and second protrusion preclude relative axial movement between said first end portion and said end portion of said first suspension tower attachment, the mating third relief and third protrusion preclude relative circumferential rotation between said second end portion and said end portion of said second suspension tower attachment, the mating fourth relief and fourth protrusion preclude relative axial movement between said second end portion and said end portion of said second suspension tower attachment.

8. A method of assembling a vehicle suspension tower brace assembly, comprising:
providing a first suspension tower attachment, a second suspension tower attachment, and a hollow body, said first suspension tower attachment having an end portion, said second suspension tower attachment having an end portion, and said hollow body having a first end portion and a second end portion;
bringing said end portion of said first suspension tower attachment together with said first end portion of said hollow body;
bringing said end portion of said second suspension tower attachment together with said second end portion of said hollow body;
deforming the brought-together end portion of said first suspension tower attachment and first end portion of said hollow body in order to interengage walls of said first suspension tower attachment and said hollow body and preclude relative movement between said first suspension tower attachment and said hollow body; and
deforming the brought-together end portion of said second suspension tower attachment and second end portion of said hollow body in order to interengage walls of said second suspension tower attachment and said hollow body and preclude relative movement between said second suspension tower attachment and said hollow body.
